(19) United States
(12) Patent Application Publication
(10) Pub. No.: US 2022/0101063 A1
(43) Pub. Date: Mar. 31, 2022

(54) METHOD AND APPARATUS FOR ANALYZING NEURAL NETWORK PERFORMANCE

(71) Applicant: SAMSUNG ELECTRONICS CO., LTD., Suwon-si (KR)

(72) Inventors: Chun Pong CHAU, Cambridge (GB); Mohamed S. ABDELFATTAH, Cambridge (GB); Lukasz DUDZIAK, Cambridge (GB); Royson LEE, Cambridge (GB); Hyeji KIM, Cambridge (GB); Nicholas Donald Atkins LANE, Cambridge (GB)

(73) Assignee: SAMSUNG ELECTRONICS CO., LTD., Suwon-si (KR)

(21) Appl. No.: 17/514,840

(22) Filed: Oct. 29, 2021

Related U.S. Application Data
(63) Continuation of application No. PCT/KR2021/012852, filed on Sep. 17, 2021.

(30) Foreign Application Priority Data
Sep. 29, 2020 (EP) 20199106.4

(51) Int. Cl. G06K 9/62; G06N 3/02

(52) U.S. Cl. CPC G06K 9/6262; G06K 9/6227; G06N 3/02; G06K 9/6232; G06K 9/6202

(57) ABSTRACT

A method of predicting performance of a hardware arrangement or a neural network model includes: obtaining one or more of a first hardware arrangement or a first neural network model, obtaining a first graphical model comprising a first plurality of nodes corresponding to the obtained first hardware arrangement or the obtained first neural network model, wherein each node of the first plurality of nodes corresponds to a respective component or device of the first plurality of interconnected components or devices or a respective operation of the first plurality of operations; extracting, based on the first graphical model, a first graphical representation of the obtained first hardware arrangement or the obtained first neural network model; predicting, based on the first graphical representation, performance of the obtained first hardware arrangement or the obtained first neural network model; and outputting the predicted performance.

### CROSS-REFERENCE TO RELATED APPLICATION(S)

This application is a bypass continuation application of International Application PCT/KR2021/012852 filed on Sep. 17, 2021, which claims priority to European Patent Application No. 20199106.4, filed on Sep. 29, 2020, in the European Patent Office, the disclosures of which are incorporated herein in their entireties by reference.

### TECHNICAL FIELD

The disclosure relates to neural networks, and in particular to a method for analyzing neural network performance using the structure of the neural network and the details of the hardware specification, and an electronic device therefore.

### BACKGROUND ART

Real-world deployment of neural networks on devices or in network-connected environments imposes efficiency and resource constraints. Neural architecture search (NAS) can automatically design competitive neural networks compared to hand-designed alternatives. However, NAS may be computationally expensive when training models. Non-trivial complexity may also be introduced into the search process. Additionally, real-world deployment demands that the neural network model meets both efficiency or hardware constraints as well as being accurate. The performance metrics which may be required may include accuracy, latency, energy and memory consumption. The process is time consuming, possibly even impractically slow and computationally expensive.

On the other hand, designing and prototyping new hardware to run evolving neural networks requires fast and accurate performance evaluation. Existing performance predictors are typically not accurate enough to capture the complexities of models running on varieties of hardware.

Accordingly, there is a need for an improved way of predicting the performance of a neural network on a particular hardware configuration.

### DISCLOSURE

### Technical Solution

According to an aspect of the disclosure, a method of predicting performance of a hardware arrangement or a neural network model may include obtaining one or more of a first hardware arrangement or a first neural network model, the first hardware arrangement including a first plurality of interconnected components or devices, the first neural network model including a first plurality of operations; obtaining a first graphical model including a first plurality of nodes corresponding to the obtained first hardware arrangement or the obtained first neural network model, wherein each node of the first plurality of nodes corresponds to a respective component or device of the first plurality of interconnected components or devices or a respective operation of the first plurality of operations; extracting, based on the first graphical model, a first graphical representation of the obtained first hardware arrangement or the obtained first neural network model; predicting, based on the first graphical representation, performance of the obtained first hardware arrangement or the obtained first neural network model; and outputting the predicted performance.

The extracting of the first graphical representation of the obtained first hardware arrangement may include extracting a feature vector for each node of the first plurality of nodes in the first graphical model.

Based on the first hardware arrangement being a single-chip device including the first plurality of interconnected components, the feature vector includes at least one of a component type or a bandwidth; and based on the first hardware arrangement being a system comprising the first plurality of interconnected devices, the feature vector includes at least one of a processor type, a device type, a clock frequency, a memory size or a bandwidth.

The extracting of the first graphical representation of the obtained first neural network model may include extracting a feature vector for each node of the first plurality of nodes in the first graphical model.

The feature vector may include at least one of an input, an output, a 3×3 convolutional layer, 1×1 a convolutional layer, or an averaging operation.

The predicting of the performance of the obtained first hardware arrangement may include at least one of: predicting individual performances of each of the first plurality of interconnected components or devices; or predicting overall performance of the first hardware arrangement.

The first graphical model may include a global node; and the predicting of the overall performance of the first hardware arrangement may be based on the global node.

The predicting of the performance of the obtained first neural network model may include predicting individual performances of each of the first plurality of operations.

The method may further include obtaining a second hardware arrangement comprising a second plurality of interconnected components or devices; obtaining a second graphical model comprising a second plurality of nodes corresponding to the obtained second hardware arrangement, wherein each node of the second plurality of nodes corresponds to a respective component or device of the second plurality of interconnected components or devices; extracting, based on the second graphical model, a second graphical representation of the obtained second hardware arrangement; predicting, based on the second graphical representation of the second hardware arrangement, performance of the obtained second hardware arrangement; and comparing the predicted performance of the obtained first hardware arrangement and the predicted performance of the obtained second hardware arrangement. The outputting of the predicted performance of the first hardware arrangement comprises outputting an indication of the predicted performance the first hardware arrangement relative to the predicted performance of the second hardware arrangement.

The method may further include obtaining a second neural network model comprising a second plurality of operations; obtaining a second graphical model comprising a second plurality of nodes corresponding to the obtained second neural network model, wherein each node of the second plurality of nodes corresponds to a respective operation of the second plurality of operations; extracting, based on the second graphical model, a second graphical representation of the obtained second neural network model; predicting, based on the second graphical representation of the obtained second neural network model, performance of the obtained second neural network model; and comparing the predicted performance of the obtained first neural network model and the performance of the obtained second neural network model. The outputting of the predicted performance of the obtained first neural network model may include outputting an indication of the predicted performance the obtained first neural network model relative to the predicted performance of the obtained second neural network model.

The method may further include a first paired combination including the obtained first hardware arrangement and the obtained first neural network model. The obtaining of the first graphical model may include obtaining a first hardware graphical model corresponding to the obtained first hardware arrangement and a first network graphical model corresponding to the obtained first neural network model. The extracting of the first graphical representation may include extracting a first hardware graphical representation of the obtained first hardware arrangement and a first network graphical representation of the obtained first neural network model. The method may further include obtaining a second paired combination comprising a second hardware arrangement and a second neural network model; obtaining a second hardware graphical model corresponding to the second hardware arrangement and a second network graphical model corresponding to the second neural network model; extracting, based on the second hardware graphical model and the second network graphical model, a second hardware graphical representation of the second hardware arrangement and a second network graphical representation of the second neural network model; predicting, based on the first hardware graphical representation and the first network graphical representation, performance of the first paired combination; predicting, based on the second hardware graphical representation and the second network graphical representation, performance of the second paired combination; comparing the predicted performance of the first paired combination and the predicted performance of the second paired combination; and outputting a relative performance of the first paired combination compared to the second paired combination.

The method may further include obtaining a plurality of hardware arrangements; predicting the performance of the obtained first neural network model on each hardware arrangement of the plurality of hardware arrangements; comparing the performances for each hardware arrangement of the plurality of hardware arrangements; and identifying, based on a predetermined performance criteria, a hardware arrangement among the plurality of hardware arrangements.

The method may further include: obtaining a plurality of neural network models; predicting the performance of the obtained first hardware arrangement on each neural network model of the plurality of neural network models; comparing the performances for each neural network model of the plurality of neural network models; and identifying, based on a predetermined performance criteria, a neural network model among the plurality of neural network models.

According to another aspect of the disclosure, a server may include a memory storing at least one instruction; and at least one processor configured to execute the at least one instruction to: obtain one or more of a first hardware arrangement or a first neural network model, the first hardware arrangement comprising a first plurality of interconnected components or devices, the first neural network model comprising a first plurality of operations; obtain a first graphical model comprising a first plurality of nodes corresponding to the obtained first hardware arrangement or the obtained first neural network model, wherein each node of the first plurality of nodes corresponds to a respective component or device of the first plurality of interconnected components or devices or a respective operation of the first plurality of operations; extract, based on the first graphical model, a first graphical representation of the obtained first hardware arrangement or the obtained first neural network model; predict, based on the first graphical representation, performance of the obtained first hardware arrangement or the obtained first neural network model; and output the predicted performance.

Accordingly to another aspect of the disclosure, a machine-readable medium may contain instructions that, when executed, cause at least one processor of an apparatus to perform operations corresponding to the analysis method.

According to another aspect of the disclosure, a method of searching for a model based on performance may include: obtaining a plurality of candidate models comprising a first candidate model; determining whether the first candidate model satisfies a predetermined constraint; based on the first candidate model satisfying the predetermined constraint, profile the first candidate model to obtain ground truth values for the first candidate model; obtain a performance of the first candidate model based on the ground truth values for the first candidate model; compare the performance of the first candidate model to a performance of a current best model; and based on the performance of the first candidate model being higher than the current best model, update the current best model to be the first candidate model.

The obtaining of the plurality of candidate models may include: obtaining a plurality of models; randomly selecting a first portion of the plurality of models; training a predictor based on the first portion of the plurality of models, wherein the predictor is configured to predict model performance; predicting a performance of each of the plurality of models; and selecting a second portion of the plurality of models having a highest performance as the plurality of candidate models.

### DESCRIPTION OF DRAWINGS

The above and/or other aspects will be more apparent by describing certain example embodiments, with reference to the accompanying drawings, in which:

FIG. 1 is a schematic diagram of a system to implement an analysis method, according to an embodiment;

FIG. 2 is a schematic diagram of a machine learning predictor, according to an embodiment;

FIG. 3a is a flow chart of example operations to predict hardware performance for a fixed neural network model, according to an embodiment;

FIG. 3b is an example graph which may be used in the method of FIG. 3a, according to an embodiment;

FIG. 3c shows a pair of matrices which may be used in the method of FIG. 3a for a hardware arrangement which is a single-chip device, a system on chip device and a network-connected system respectively, according to an embodiment;

FIG. 3d shows a pair of matrices which may be used in the method of FIG. 3a for a hardware arrangement which is a single-chip device, a system on chip device and a network-connected system respectively, according to an embodiment;

FIG. 3e shows a pair of matrices which may be used in the method of FIG. 3a for a hardware arrangement which is a single-chip device, a system on chip device and a network-connected system respectively, according to an embodiment;

FIG. 3f is an example of an output graphical representation, according to an embodiment;

FIG. 4a is a flow chart of example operations to predict performance for a plurality of neural network models on a fixed hardware arrangement, according to an embodiment;

FIG. 4b illustrates a pair of matrices which may be used in the method of FIG. 4a;

FIG. 5 is a schematic diagram of another machine learning predictor, according to an embodiment;

FIG. 6 is a flow chart of example operations to predict hardware performance using the predictor of FIG. 5, according to an embodiment;

FIG. 7 is a schematic diagram of another machine learning predictor, according to an embodiment;

FIG. 8 is a flow chart of example operations to predict hardware performance using the predictor of FIG. 7, according to an embodiment;

FIG. 9 is a schematic diagram of another machine learning predictor, according to an embodiment

FIG. 10 is a flow chart of examples operations for training the predictors, according to an embodiment;

FIG. 11a is a flow chart showing two phases of a neural architecture search using the predictor of FIG. 7, according to an embodiment; and

FIG. 11b is a flow chart showing two phases of a neural architecture search using the predictor of FIG. 7, according to an embodiment.

### MODE FOR INVENTION

Hereinafter, the disclosure will be described in detail by explaining embodiments of the disclosure with reference to the attached drawings. The disclosure may, however, be embodied in many different forms and should not be construed as being limited to the embodiments set forth herein. In the drawings, parts not related to the disclosure are not illustrated for clarity of explanation, and like reference numerals denote like elements throughout.

Although the terms used herein are selected, as much as possible, from general terms that are widely used at present while taking into consideration the functions obtained in accordance with the disclosure, these terms may be replaced by other terms based on intentions of one of ordinary skill in the art, customs, emergence of new technologies, or the like. In a particular case, terms that are arbitrarily selected by the applicant may be used and, in this case, the meanings of these terms may be described in relevant parts of the disclosure. Therefore, it is noted that the terms used herein are construed based on practical meanings thereof and the whole content of this specification, rather than being simply construed based on names of the terms.

As used herein, the singular forms “a”, “an”, and “the” are intended to include the plural forms as well, unless the context clearly indicates otherwise. All terms (including technical and scientific terms) used herein have the same meaning as generally understood by one of ordinary skill in the art.

It will be understood that the terms “comprises”, “comprising”, “includes” and/or “including”, when used herein, specify the presence of stated elements, but do not preclude the presence or addition of one or more other elements, unless otherwise indicated herein. As used herein, the term “unit” or “module” denotes an entity for performing at least one function or operation, and may be implemented as hardware, software, or a combination of hardware and software.

The terms “comprises”, “comprising”, “includes” and/or “including”, when used herein, specify the presence of stated elements, but do not preclude the presence or addition of one or more other elements, unless otherwise indicated herein.

The phrase “configured (or set) to” as used herein may be interchangeably used with, for example, “suitable for”, “having the capacity to”, “designed to”, “adapted to”, “made to”, or “capable of” depending on the circumstances. The phrase “configured (or set) to” may not necessarily represent only “specifically designed to” in terms of hardware. Instead, in a certain circumstance, the phrase “a system configured to” may represent that the system is “capable of” something in conjunction with other devices or components. For example, the phrase “a processor configured (or set) to perform A, B, and C” may refer to a dedicated processor (e.g., an embedded processor) for performing those operations or a generic-purpose processor (e.g., a central processing unit (CPU) or an application processor (AP)) for performing those operations by executing one or more software programs stored in memory.

In a first approach of the present disclosure according to an embodiment, a computer implemented method uses a trained predictor for predicting performance of a neural network on a hardware arrangement. The method may include obtaining a hardware arrangement including a plurality of interconnected components or devices and a neural network model which is to be implemented on the hardware arrangement; obtaining a graphical model for representing hardware arrangements, wherein the graphical model includes a plurality of connected nodes; extracting, using a feature extractor of the trained predictor, a graphical representation of the hardware arrangement using the graphical model, wherein each of the interconnected components or devices is represented by one of the plurality of connected nodes; predicting, using the trained predictor, performance of the neural network model on the hardware arrangement using the extracted graphical representation of the hardware arrangement; and outputting the predicted performance.

According to another embodiment, a server may include a trained predictor for carrying out the method of predicting performance of a neural network on a hardware arrangement.

The hardware arrangement may be selected from a single-chip device including a plurality of interconnected components (including but not limited to memory, processor, buffer and pool) and a system including a plurality of interconnected devices. The system may be a system-on-chip including a plurality of interconnected devices or a system including a plurality of network connected devices.

The neural network model may be a deep neural network. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. For example, a CNN may be composed of different computational blocks or operations selected from conv1×1, conv3×3 and poll3×3.

Obtaining the hardware arrangement and the neural network model may include first obtaining the hardware arrangement and then obtaining the neural network model or vice versa. Obtaining the hardware arrangement and/or the neural network model may include obtaining details of the hardware arrangement and/or the neural network model. The details of the hardware arrangement may include the features of the components and/or devices within the hardware arrangement. The details of the neural network model may include the details of the operations.

Extracting a graphical representation of the first hardware arrangement may include extracting a feature vector for each node of the plurality of connected nodes in the graphical model. For example, when the hardware arrangement is a single-chip device, the feature vector may include component type and bandwidth. When the hardware arrangement is a system, the feature vector may include multiple features selected from processor type, device type, clock frequency, memory size and bandwidth.

The feature extractor may be a graph convolutional network having k layers and may extract the graphical representation using a layer wise propagation rule as shown in Equation 1:

Vⁿ⁺¹=g(Vⁿ,A)=σ(AVⁿWⁿ) [Equation 1]

where A is an adjacency matrix, Vⁿ and Wⁿ are the feature matrix and weight matrix at the n-th layer respectively, g is the propagation function, e.g. graph convolution and σ( ) is a non-linear activation function. The method may include an optional operation of initializing the weights.

Predicting performance of the neural network model on the first hardware arrangement may include at least one of: predicting individual performances of each interconnected component or device within the hardware arrangement; and predicting overall performance of the first hardware arrangement. For example, the graphical model may include a global node and predicting the overall performance of the first hardware arrangement may use the global node. The global node may be described as a node that connects to all the other models and may be used to aggregate all node-level information within the graphical model.

The trained predictor may include a fully connected layer which may include one layer or a plurality of layers. The performance may be predicted by inputting each feature vector(s) to the fully connected layer.

Different performance metrics may be output as desired and may include one or more of accuracy, latency, energy consumption, thermals and memory utilization. The same or different performance metrics may be output for the individual performance of the interconnected components or device and the overall performance.

Obtaining a hardware arrangement may include generating a plurality of designs (manually or automatically) and selecting the hardware arrangement. The method of predicting performance may be used to search through the plurality of designs to select a hardware arrangement which is optimized for a particular neural network. Thus, according to an embodiment, a computer implemented method may design a hardware arrangement for implementing a neural network model, the method may including obtaining a plurality of hardware arrangements; predicting the performance of the neural network model on each hardware arrangement in the plurality of hardware arrangements using the methods described above; comparing the predicted performances for each hardware arrangement and selecting the hardware arrangement having a preferred predicted performance. For example, the preferred predicted performance may be the arrangement with the highest accuracy and/or the lowest latency.

The trained predictor may include at least a first feature extractor and a second feature extractor. There may be a plurality of feature extractors. Each feature extractor may extract a separate feature vector and the feature vectors may be combined to give a multi-valued vector which may be used to predict performance. When the inputs to the feature extractors are the same, e.g. both hardware arrangements or both paired hardware and neural network models, the extractors may use shared weights, i.e. the same weights. By using the same weights, the feature extraction may be termed symmetric and thus input i1 and i2 will generate the same output as input i2 and i1. The use of shared weights may be particularly important when using a binary predictor in which performance scores are compared.

In a first example, the first feature extractor may extract a graphical representation of the hardware arrangement and the second feature extractor may extract a graphical representation of the neural network model. According to an embodiment, the method may also include obtaining a graphical model including a plurality of connected nodes for representing neural network models and extracting, using the second feature extractor of the trained predictor, a graphical representation of the neural network model using the graphical model, wherein each of operation of the neural network model is represented by one of the plurality of connected nodes.

According to an embodiment, predicting performance of the neural network model on the hardware arrangement may use both the extracted graphical representations of the hardware arrangement and the neural network model. Predicting performance of the neural network model on the hardware arrangement may include predicting individual performances of each operation of the neural network model. This may be in addition or instead of predicting the performance of the individual components/device and overall performance described above.

Obtaining a neural network model may include generating a plurality of designs (manually or automatically) and selecting the neural network model. It will be appreciated that the method of predicting performance may be used to search through the plurality of designs of both hardware arrangement and neural network models to select a hardware arrangement which is optimized for a particular neural network. Thus, according to an embodiment, a computer implemented method may design a hardware arrangement for implementing a neural network model, the method may include obtaining a plurality of hardware arrangements; predicting the performance of the neural network model on each hardware arrangement in the plurality of hardware arrangements using the method described above; and comparing the predicted performances for each hardware arrangement and selecting the hardware arrangement having a preferred predicted performance.

In another example, the first feature extractor may extract a graphical representation of the hardware arrangement and the second feature extractor may extract a graphical representation of a second, different hardware arrangement. When each feature extractor receives the same type of input (e.g. hardware arrangement only, neural network model only or paired combination), it may not be necessary to obtain an absolute value for the performance of a neural network model on a particular hardware arrangement but it may be sufficient to compare the performances. For example, if each feature extractor receives a different hardware arrangement, the method may include comparing the performances of the neural network model on the different hardware arrangements to determine which hardware arrangement is best, e.g. most accurate or has the lowest latency.

The method may further include obtaining a second hardware arrangement including a plurality of interconnected components or devices; extracting, using a second feature extractor of the trained predictor, a graphical representation of the second hardware arrangement; predicting, using the trained predictor, performance of the neural network model on the second hardware arrangement using the extracted graphical representation of the second hardware arrangement; comparing the predicted performance of the neural network model on the hardware arrangement and the predicted performance of the neural network model on the second hardware arrangement; and wherein outputting the predicted performance includes outputting an indication of the performance of the neural network model on the hardware arrangement relative to the performance of the neural network model on the second hardware arrangement.

The hardware arrangement and the neural network model may be considered to be a first paired arrangement. The method of comparing two different hardware arrangements may be extended to comparing two different pairs of neural network models and hardware arrangements. Where there are different paired arrangements, at least one or both of the hardware arrangement and the neural network model is different.

The method may further include obtaining a graphical model for representing neural network models, wherein the graphical model includes a plurality of connected nodes; and extracting, using the first feature extractor of the trained predictor, a graphical representation of the neural network model, wherein each of the operations is represented by one of the plurality of connected nodes. In other words, the first feature extractor may extract a graphical representation of the hardware arrangement in the first paired arrangement and a graphical representation of the neural network in the first paired arrangement.

The method may further include obtaining a second hardware arrangement including a plurality of interconnected components or devices and a second neural network model which is to be implemented on the second hardware arrangement; and extracting, using a second feature extractor of the trained predictor, a graphical representation of the second hardware arrangement and a graphical representation of the second neural network model. The second hardware arrangement and the second neural network model may be considered to be a second paired arrangement.

Where there are two paired arrangements, the method may further include predicting, using the trained predictor, performance of the neural network model on the hardware arrangement using the extracted graphical representation of the hardware arrangement and the extracted graphical representation of the neural network model and predicting, using the trained predictor, performance of the second neural network model on the second hardware arrangement using the extracted graphical representation of the second hardware arrangement and the extracted graphical representation of the second neural network model. The method may further include comparing the predicted performance of the neural network model on the hardware arrangement and the predicted performance of the second neural network model on the second hardware arrangement.

When comparing predicted performances, the predicted performance may be a performance score rather than an absolute value of the performance. Outputting the predicted performance may include outputting an indication of the performance of one arrangement relative to the performance of the second arrangement. For example, the indication may be a probability distribution which includes a first probability that the first paired arrangement is better than the second paired arrangement and a second probability that the second paired arrangement is better than the first paired arrangement. The comparing operation may be performed by a classifier, e.g. a SoftMax classifier or a sigmoid classifier.

Each neural network model may be selected from a neural network model search space and similarly each hardware arrangement may be selected from a hardware search space. It will be appreciated that the method of predicting performance may be used to search through the plurality of designs of both hardware arrangement and neural network models to select an optimized combination. Thus, an embodiment, a method may design hardware for implementing a neural network model, the method may include obtaining a plurality of hardware arrangements; obtaining a plurality of neural network models; generating a plurality of paired combinations of neural network models and hardware arrangements, wherein each paired combination includes a neural network model selected from the plurality of neural network models and a hardware arrangement selected from the plurality of hardware arrangements; predicting the relative performance of each paired combination using the method described above; and ranking each paired combination based on the output relative performances and selecting the highest ranked paired combination.

The overall search space may thus be large but there may be a relatively small number of combination available for training. The search space may be denoted by M and there may be a budget of T models which can be trained and I iterations. The method may thus include an iterative data selection when training the predictor whereby the predictor is focused on predicting rankings of top candidates. According an embodiment, there is provided a method for training a predictor to be used in the method described above, the method including selecting a group of paired combinations from a search space of paired combinations; training the predictor using the selected group of paired combinations; predicting, after training, the relative performance of all paired combinations in the search space; ranking each paired combination in the search spaced based on the predicted relative performance; and repeating the selecting, training, predicting and ranking operations; wherein a first group of paired combinations is selected randomly and subsequent groups of paired combinations are a group of the highest ranked paired combinations.

In the arrangements described above, the graphical model for representing neural network models may have the same structure as the graphical model for representing hardware arrangements, i.e. both may include a plurality of connected nodes, including a global node. It will be appreciated that the nodes and the connections represent different features for neural network models and hardware arrangements. For the neural network each node may represent an operation. Extracting a graphical representation of the neural network model may include extracting a feature vector for each node of the plurality of connected nodes in the graphical model. The feature vector may include features of the operation, e.g. input, output, a 3×3 convolutional layer, a 1×1 convolutional layer and an averaging operation.

The method described above may be wholly or partly performed on an apparatus, i.e. an electronic device or server, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers, e.g. a graph convolutional network and/or a fully connected layer. Each of the plurality of neural network layers includes a plurality of weight values and performs neural network computation by computation between a result of computation by a previous layer and the plurality of weight values. The weight values may be obtained during training. The weights may be initialized during training, e.g. by randomly selecting the weights or by selecting the weights from a source predictor which has previously been trained on a different arrangement.

As mentioned above, embodiments may be implemented using an AI model in the predictor and thus the predictor may be termed a machine learning predictor. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model may be provided through training or learning. Being provided through learning may mean that, by applying a learning algorithm to a plurality of learning data, a predefined operating rule or AI model of a desired characteristic is made. The learning may be performed in a device itself in which AI according to an embodiment is performed, and/or may be implemented through a separate server/system.

According to an embodiment, there is provided a non-transitory data carrier carrying processor control code to implement the methods described herein.

As will be appreciated by one skilled in the art, the analysis process may be embodied as a system, method or computer program product. Accordingly, the analysis process may take the form of an entirely hardware embodiment, an entirely software embodiment, or an embodiment combining software and hardware aspects.

Furthermore, the analysis process may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of embodiments may be written in any combination of one or more programming languages, including object oriented programming languages and conventional procedural programming languages. Code components may be embodied as procedures, methods or the like, and may include sub-components which may take the form of instructions or sequences of instructions at any of the levels of abstraction, from the direct machine instructions of a native instruction set to high-level compiled or interpreted language constructs.

Embodiments may also provide a non-transitory data carrier carrying code which, when implemented on a processor, causes the processor to carry out any of the methods described herein.

Embodiments may further provide processor control code to implement the above-described methods, for example on a general purpose computer system or on a digital signal processor (DSP). Embodiments may also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments described herein may include source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. Embodiments may include a controller which includes a microprocessor, working memory and program memory coupled to one or more of the components of the system.

It will also be clear to one of skill in the art that all or part of a logical method according to embodiments may suitably be embodied in a logic apparatus including logic elements to perform the operations of the above-described methods, and that such logic elements may include components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

Embodiments may be implemented in the form of a data carrier having functional data thereon, said functional data including functional computer data structures to, when loaded into a computer system or network and operated upon thereby, enable said computer system to perform all the operations of the above-described method.

Broadly speaking, embodiments relate to methods, apparatuses and systems for predicting the performance of a neural network model on a hardware arrangement and of searching for optimal paired combinations based on the performance. Embodiments may include obtaining absolute values for performance or comparing the relative performance of two or more inputs to rank the inputs. Graphical representations of one or both of the neural network model and hardware arrangements may be extracted and used in embodiments.

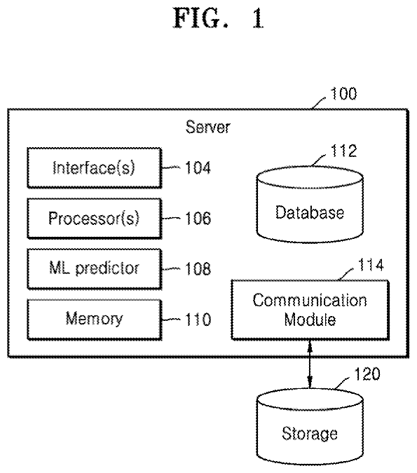

FIG. 1 is a schematic diagram of a server 100 to implement the analysis method according to an embodiment. The server 100 may include one or more interfaces 104 that enable the server 100 to receive inputs and/or provide outputs. For example, the server 100 may include a display screen to display the results of implementing a machine learning predictor (e.g. to predict performance as described below). The server 100 may include a user interface for receiving, from a user, a query to determine performance of a particular combination of neural network and hardware.

The server 100 may include at least one processor or processing circuitry 106. The processor 106 controls various processing operations performed by the server 100, such as implementing at least part of a machine learning predictor 108 on the server 100. The processor may include processing logic to process data and generate output data/messages in response to the processing. The processor may include one or more of: a microprocessor, a microcontroller, and an integrated circuit.

The server 100 may include memory 110. Memory 110 may include a volatile memory, such as random access memory (RAM), for use as temporary memory, and/or non-volatile memory such as Flash, read only memory (ROM), or electrically erasable programmable ROM (EEPROM), for storing data, programs, or instructions, for example.

The server 100 may include at least one machine learning (ML) predictor 108. The at least one machine learning predictor 108 may be stored in memory 110. As explained in more detail below, the at least one machine learning predictor 108 may include a source predictor and a target predictor. The source predictor may be used to initialize the weights used in the target predictor.

The server 100 may include a communication module 114 to enable the server 100 to communicate with other devices/machines/components, thus forming a system. The communication module 114 may be any communication module suitable for sending and receiving data. The communication module may communicate with other machines using any one or more of: wireless communication (e.g. WiFi), hypertext transfer protocol (HTTP), message queuing telemetry transport (MQTT), a wireless mobile telecommunication protocol, short range communication such as radio frequency communication (RFID) or near field communication (NFC), or by using the communication protocols specified by ZigBee, Thread, Bluetooth, Bluetooth LE, IPv6 over Low Power Wireless Standard (6LoWPAN), Constrained Application Protocol (CoAP), wired communication. The communication module 114 may use a wireless mobile (cellular) telecommunication protocol to communicate with machines in the system, e.g. 3G, 4G, 5G, 6G etc. The communication module 114 may communicate with machines in the system 100 using wired communication techniques, such as via metal cables or fiber optic cables. The server 100 may use more than one communication technique to communicate with other components. It will be understood that this is a non-exhaustive list of communication techniques that the communication module 114 may use. It will also be understood that intermediary devices (such as a gateway) may be located between the server 100 and other components in the system, to facilitate communication between the machines/components.

The server 100 may be a cloud-based server. The machine learning model may be trained in the server 100 for deployment on other electronic devices. The machine learning predictor 108 may have been trained using a training data set, which may be stored in storage 120 or database 112. Storage 120 or database 112 may be remote (i.e. separate) from the server 100 or may be incorporated in the server 100.

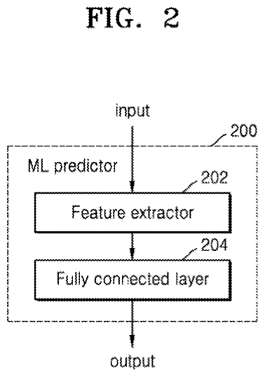

FIG. 2 is a schematic block diagram illustrating one possible arrangement of the (or each) machine learning predictor of FIG. 1, according to an embodiment. The machine learning predictor 200 may include a feature extractor 202 and a fully connected layer 204. The feature extractor 202 may be a graph based feature extractor which extracts a graph based representation of the input(s). For example, the feature extractor 202 may a graph convolutional network including a plurality of layers. The number of layers may be between 1 and 10 layers and four layers may be a suitable number, for example as described in “BRP-NAS: Prediction based NAS using GCNs” by Dudziak et al published as arXIV:2007.08668. This paper is incorporated by reference herein in its entirety. Any suitable feature extractor which extracts a graph based representation of the inputs may be used and other examples are described in “A comprehensive surface on graph neural networks” by Wu et al published in Journal of Latex Class Files in August 2019 which is also incorporated by reference herein in its entirety. The fully connected layer 204 is represented in this arrangement by a single layer but may include multiple layers which are adjusted to fit the complexity, suitable examples include 3 and 4 layers.

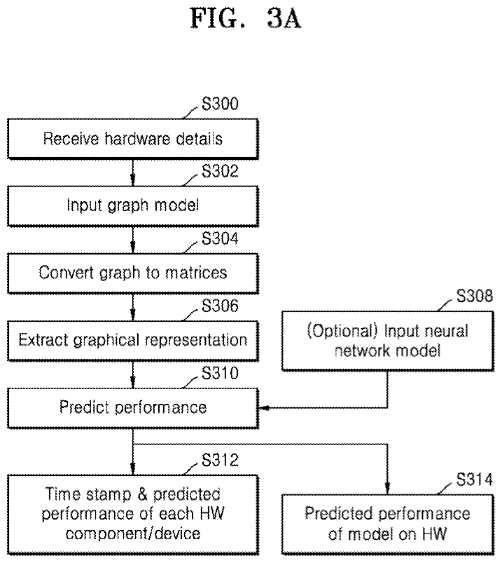

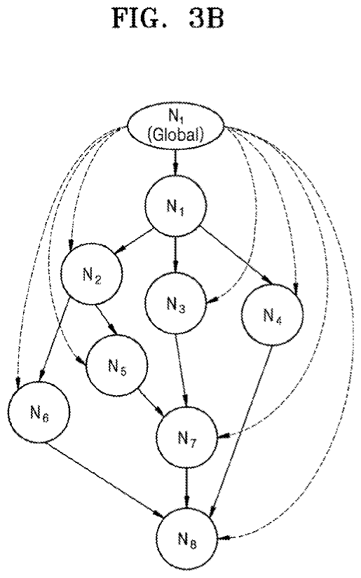

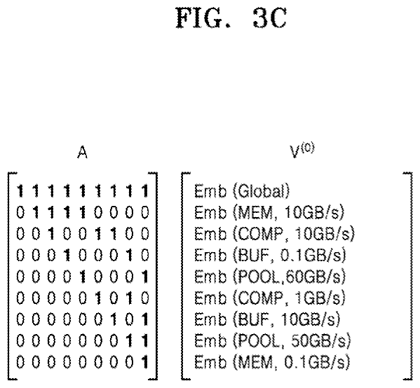

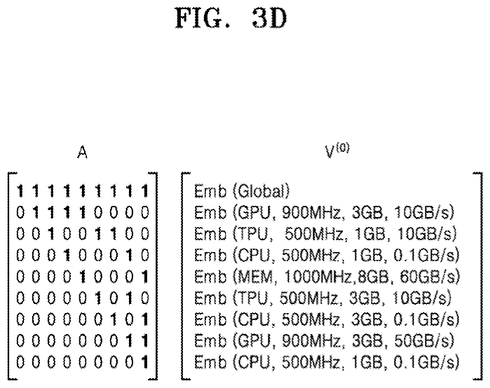

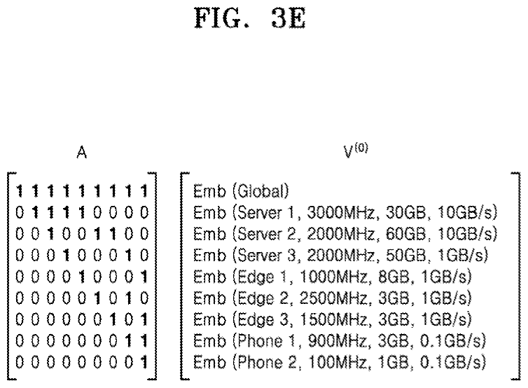

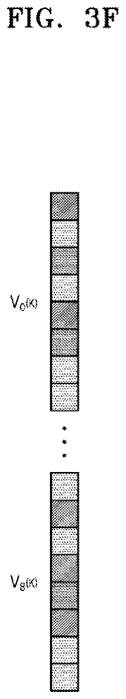

FIG. 3a is a flow chart of example operations to perform performance prediction of a plurality of hardware arrangements implementing a fixed neural network model using the server of FIG. 1 and particularly the predictor of FIG. 2, according to an embodiment. Operation S300 obtains (i.e. receive or input) hardware details. The details may be received by generating a plurality of designs and selecting a first hardware arrangement from the plurality of designs. The details of the hardware may include the type of components or devices within the hardware arrangement as well as other implementation details, such as bandwidth, clock frequency, memory size and information on the connections between the components and devices. The details may be used to map the hardware arrangement to a graphical model and thus generate a graphical representation of the hardware arrangement as described below.

At operation S302, a graphical model which is suitable for representing the plurality of designs is obtained or inputted. An example of a graphical model is shown in FIG. 3b. The graphical model may be a computational graph which may be designed manually or generated automatically (e.g. by AutoML tools). The graphical model may represent each hardware design as a plurality of connected nodes. In this example, there are eight nodes each of which represents a component or device within the hardware design. The edges of the graphical model (or graph) represent the connections between each component or device. It will be appreciated that the number shown in FIG. 3b is merely indicative. The graph also includes a global node which is a node that connects to all the other models and may be used to capture the graph embedding of neural architecture by aggregating all node-level information.

Returning to FIG. 3a and depending on the implementation of the machine learning predictor, operation S304 may convert the graph to matrices. For example, the graph may be converted to an adjacency matrix A and a feature matrix or vector V. Each entry Aᵢⱼ in the adjacency matrix is a connection from node i to node j. The adjacency matrix is typically asymmetric because the computation flow is represented as a directed graph as shown in FIG. 3b. The feature matrix V may be a one-hot encoding, i.e. zero and skip-connect operations may be optimized out. Each feature vector Vᵢ^{(m)} is the embedding of node i encapsulating the node parameters at layer m in the feature extractor.

Examples of matrices are shown in FIGS. 3c to 3e. In FIG. 3c, the plurality of hardware designs are each single-chip devices with multiple interconnected components. In this arrangement, the feature matrix includes a function “emb” which encapsulates the parameters of the hardware components in a feature vector. The features which are encapsulated for each of the component nodes N₁ to N₈ are component type and bandwidth. In this example, the component types includes memory (MEM), computer processor (COMP), buffer (BUF) and pool (POOL) and the bandwidths range between 0.1 GB/s and 60 GB/s as indicated. However, it will be appreciated that these features are illustrative and others may be included.

In FIG. 3d, the plurality of hardware designs are each system on chip devices with multiple interconnected devices. As in FIG. 3c, the feature matrix includes a function “emb” which encapsulates the parameters of the hardware devices in a feature vector. In this arrangement, the features which are encapsulated for each of the component nodes N₁ to N₈ are processor type, clock frequency, memory size and bandwidth. Merely for illustration, the device types include devices having processor types selected from GPU, TPU, CPU and memory (MEM), the clock frequencies range between 500 MHz and 100 MHz, the memory sizes range between 1 GB and 8 GB and the bandwidths range between 0.1 GB/s and 60 GB/s as indicated.

In FIG. 3e, the plurality of hardware designs are each systems with multiple network-connected devices. As in FIGS. 3c and 3d, the feature matrix includes a function “emb” which encapsulates the parameters of the hardware devices in a feature vector. As in FIG. 3d, the features in the feature vector for each of the component nodes N₁ to N₈ are device type, clock frequency, memory size and bandwidth. Merely for illustration, the device types include devices having processor types selected from server 1 to server 3, edge 1 to edge 3 and phone 1 or phone 2, the clock frequencies range between 100 MHz and 3000 MHz, the memory sizes range between 1 GB and 60 GB and the bandwidths range between 0.1 GB/s and 10 GB/s as indicated.

Returning to FIG. 3a, operation S306 may include extracting the graphical representation, e.g. using the feature extractor. For a feature extractor which uses a graph convolutional network having k layers, the input may be the adjacency matrix A and an initial feature matrix Vⁿ. The output is V^{k}. For each of the layers n=0 to n=k−1 in the feature extractor, the layer wise propagation rule is shown in Equation 2:

Vⁿ⁺¹=g(Vⁿ,A)[=σ(AVⁿWⁿ)] [Equation 2]

where Vⁿ and Wⁿ are the feature matrix and weight matrix at the n-th layer respectively, g is the propagation function. Where the propagation is a graph convolution, the propagation may be expressed using σ( ) which is a non-linear activation function like ReLU. This part specific to graph convolution is indicated in square brackets. During each iteration, each node aggregates labels of its neighboring node via the function g and this aggregation is repeated the same number of times as there are layer. A schematic illustration of the output graphical representation is shown in FIG. 3f and there is a feature vector output for each node, including the global node.

As shown above, the step of extracting a graphical representation comprises using one or more weight matrices. Each layer may have a different matrix. The weights may be determined during training. Before training, the weights may be randomly initialized or optionally initialized by the weights of another trained predictor which may be termed a source predictor. The source predictor may be configured in the same way as the feature extractor shown in FIG. 2. Merely, as an example, the source predictor may have been used to predict the latency of the same set of hardware designs implementing a different fixed neural network model.

Operation S308 may be options. If the predictor has been trained to predict the performance of hardware on a fixed neural network, the predictor may be used to predict the performance of the new hardware details without further information about the neural network model. However, if there are a plurality of predictors, each of which targets a different neural network model, it is necessary to input the neural network algorithm or model which is to be implemented on the plurality of hardware designs at operation S308. This input will help distinguish the different models but is described as optional because it may not be necessary. It will be appreciated that, if used, this operation can be done simultaneously with any of operations S300 to S304 (not just S306 as schematically illustrated). Similarly, this inputting operation may be done before or after operations S300 to S308.

Operation S310 may include predicting the performance of the input fixed neural network on each of the set of hardware designs. The performance may be predicted using the feature vectors which were output from the feature extractor. For example, each output feature vector may be input to the fully connected layer which outputs the performance. The fully connected layer may be trained as explained in more detail to map these representations of the nodes (including the global node) to performance metrics. The predicted performance may also use weights for each feature in the vector. As above, the weights may be determined during training. At this operation, which is an inference operation, the trained weights may be loaded to the predictor. Each output of the fully connected layer (FC) corresponds as shown in FIG. 3f to the performance prediction for each node, i.e. for each component in the arrangement of FIG. 3c in which there is a single-chip device or for each device in the arrangements of FIGS. 3d and 3e which are system on chip and a network connected system respectively.

Returning to FIG. 3a, one possible output as shown in operation S312 is to predict the individual performance of each component (FIG. 3c) or each device (FIGS. 3d and 3e) and an associated time stamp if required. This may be done using the outputs generated by each of the output feature vectors for the nodes N₁ to N₈. The use of a global node also means that as shown in operation S314, the performance of the model on each hardware set-up as a global arrangement, e.g. a single-chip device, a system on chip or a network connected system, may be output. Different performance metrics may be output as desired and may include one or more of accuracy, latency, energy consumption, thermals and memory utilization. For example, latency or energy consumption for each component/device and overall latency for the hardware may be predicted. Alternatively, overall latency may be predicted and a measure of the utilization of each device may be predicted—this may be particularly appropriate for the system-on-chip arrangement in FIG. 3d. The prediction whether for an individual component/device or for the whole system is an absolute value for the selected performance metric.

As set out above, the details of the hardware arrangement may be obtained by generating a plurality of designs and selecting a first hardware arrangement from the plurality of designs. It will thus be appreciated that the performance may be predicted for some or all of the hardware designs which are generated in this initial operation. In this way, the method of FIG. 3a may be used in a search for a neural architecture design. For example, the performance of the fixed neural network model on each hardware arrangement may be predicted and then compared. The hardware arrangement having a preferred or optimal predicted performance may then be selected.

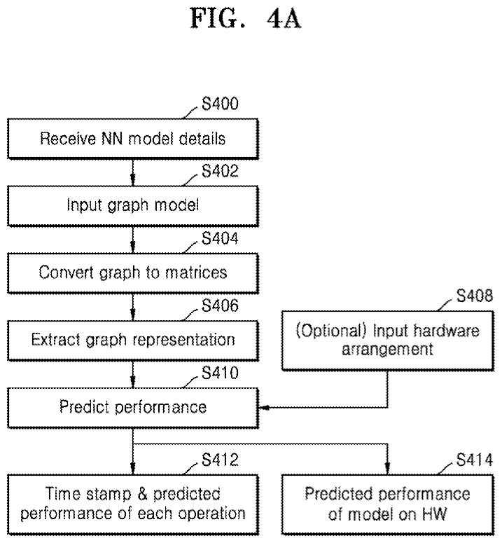

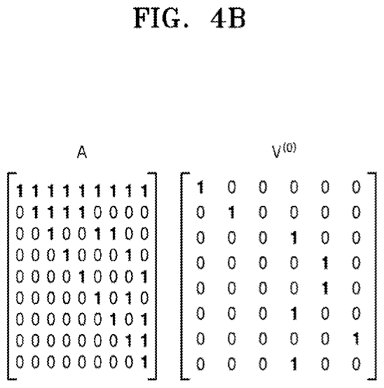

FIG. 4a shows a method which may be implemented using the predictor shown in FIG. 2, according to an embodiment. In this method, the performance of different neural network models may be evaluated for a fixed hardware arrangement in contrast to the performance of a fixed NN model on different hardware arrangements. At operation S400, a NN model details are received or inputted. The details may be received by generating a plurality of designs. At operation S402, a graphical model of the plurality of designs may be input. For the sake of simplicity, the graph used in this method is the same as the one shown in FIG. 3b. In this arrangement, the nodes N₁ to N₈ each represent an operation of a layer within the model and the computational flow is represented by an edge. There is also a global node as before. However, it will be appreciated that different graphs may be used if appropriate.

Operation S404 may include converting the graph to matrices. An example adjacency matrix A and feature matrix V is shown in FIG. 4b. In this arrangement, as above each row is a one-hot vector encoding the features of an operation. The function “emb” is used to encapsulate the parameters of the neural network model in a feature vector. As an example, the features illustrated here include the global operation, an input, an output, a 3×3 convolutional layer, a 1×1 convolutional layer and an averaging operation. It will be appreciated that the use of one-hot encoding is an example for illustration. The features illustrated are also merely indicative.

Returning to FIG. 4a, operation S406 may include extracting the graphical representation, e.g. using the feature extractor. The layer wise propagation rule may be the same as listed above. As above, where weight matrices are used, the weights used for extracting the graph representation may be generated during training, optionally initializing based on weights from a source predictor. Merely as an example, during training a source predictor may be trained to predict the accuracy of the same fixed hardware arrangement, the latency of a different hardware arrangement or even an energy prediction for a different hardware arrangement.

In a similar manner to FIG. 3a, if the predictor has been trained to predict the performance of a neural network model for a fixed hardware design, the predictor may be used to predict the performance of the new neural network models without further information about the hardware design. However, if there are multiple predictors, each of which targets a different hardware design, it is necessary to input the hardware arrangement on which each of the neural network models are to be implemented (operation S408). As before, the order of the operations may be changed. Thus, operation S408 is optional depending on the circumstance.

Operation S410 may include predicting the performance of each input neural network model on the fixed hardware design (operation S410). The performance may be predicted using the feature vector outputs from the feature extractor which are input to the fully connected layer. One possible output as shown in operation S412 is to predict the performance of each operation and an associated time stamp if required. The use of a global node also means that as shown in operation S414, the performance of each model on the hardware may also be output. Typically, overall latency may be predicted together with the latency associated with each operation.

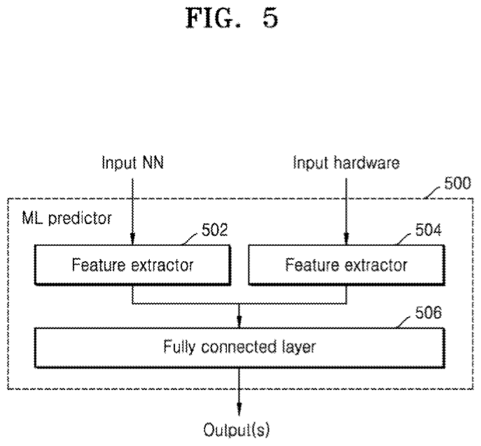

FIG. 5 is a schematic block diagram showing another possible arrangement of the (or each) machine learning predictor of FIG. 1 according to an embodiment. The machine learning predictor 500 may include a first feature extractor 502, a second feature extractor 504 and a fully connected layer 506. As before, each feature extractor 502,504 may be a graph based feature extractor which extracts a graph based representation of the input(s). In this arrangement, the first feature extractor 502 extracts a graphical representation of an input neural network model and the second feature extractor 504 extracts a graphical representation of an input hardware arrangement. The graphical representations are combined by the fully connected layer 506 to generate one or more outputs as described below.

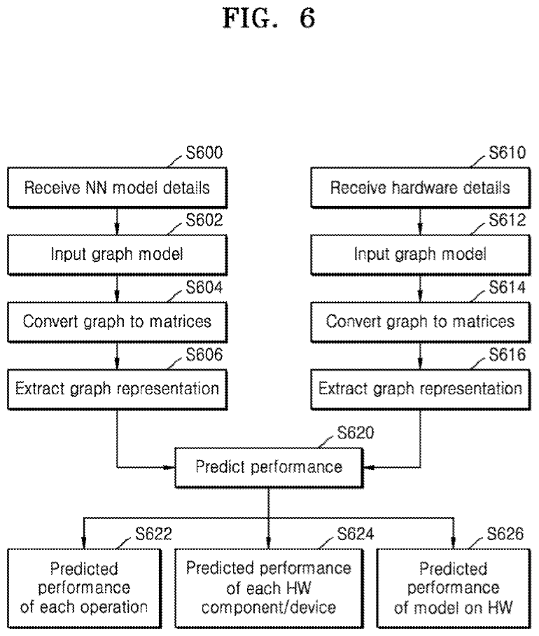

FIG. 6 is a flow chart showing operations to perform performance prediction, according to an embodiment. This method essentially combines the features of FIGS. 3a and 4a to predict performance of new hardware arrangements running unseen models. As shown in FIG. 6, Operation S600 may include receiving or inputting neural network models and operation S602 may include inputting a graphical model of the plurality of designs. At operation S604, the graphical model may be represented as matrices so that a final graphical representation may be extracted using the feature extractor at operation S606. The operations S600 to S604 are the same as operations S400 and S404 in FIG. 4a.

Embodiments may also include receiving or inputting hardware details (operation S610) and then inputting a graphical model of the plurality of designs (operation S612). The graphical model may be represented as matrices (operation S614) so that a final graphical representation may be extracted using the feature extractor (operation S616). The operations S610 through S614 are the same as operations S300 and S304 in FIG. 3a.

The first and second feature extractors may each use a graph convolutional network having k layers. The inputs to the first feature extractor may be the adjacency matrix A_{N} and an initial feature matrix V_{N}⁰ both of which describe the neural network model. The inputs to the second feature extractor may be the adjacency matrix A_{H} and an initial feature matrix V_{H}⁰ both of which describe hardware arrangement. For each of the layers n=0 to n=k−1 in each feature extractor, the layer wise propagation rule is shown in Equations [3] and [4], respectively

V_{N}ⁿ⁺¹=g(V_{N}ⁿ,A_{N})=σ(A_{N}V_{N}ⁿW_{N}ⁿ) Equation [3]

V_{H}ⁿ⁺¹=g(V_{H}ⁿ,A_{N})=σ(A_{H}V_{H}ⁿW_{H}ⁿ) Equation [4]

where W_{H}ⁿ and W_{N}ⁿ are the weight matrices for the hardware arrangement and the neural network model respectively at the n-th layer, g is the propagation function and σ( ) is a non-linear activation function like ReLU which is specific to graph convolution as described above. During each iteration, each node aggregates labels of its neighboring node via the function g and this aggregation is repeated the same number of times as there are layers.

As before, in the example in which graph convolution is used, one or more weight matrices are used. Accordingly, there may be an operation of loading the weights before extracting the graphical representations in operations S606 or S616. The weights may be obtained during the training of the predictor, including optionally initializing based on weights from a source predictor.

Operation S620 may include predicting the performance of each input neural network model on each hardware design. The performance may be predicted using the feature vectors which are output from the first and second feature extractors respectively. There are more inputs and thus more outputs. As before, weights may also be used in this process and the weights may be obtained during training as explained above.

One possible output as shown in operation S622 is to predict the performance of each operation in each neural network model. Another possible output as shown in operation S624 is to predict the performance of each component/device in each hardware arrangement. As shown in operation S626, the performance of each model on each hardware arrangement may also be output.

The details of the hardware arrangement may be obtained by generating a plurality of designs and similarly the details of the neural network model may be obtained by generating a plurality of designs. The hardware arrangements and the neural network models may be paired to generate a plurality of paired combinations. Each paired combination has a hardware arrangement associated with a neural network model. Each paired combination thus includes a neural network model selected from the plurality of neural network models and a hardware arrangement selected from the plurality of hardware arrangements. The same neural network model may be selected multiple times and paired with different hardware arrangements and vice versa. Accordingly, the search space is large. The performance may be predicted for some or all of the paired combination. In this way, the method of FIG. 6 may be used in a search for a neural architecture design. For example, the performance of each paired combination may be predicted and then compared. The paired combination having a preferred or optimal predicted performance may then be selected.

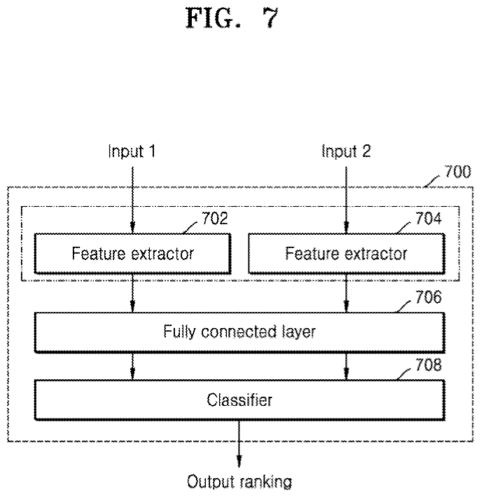

FIG. 7 is a schematic block diagram showing another possible arrangement of a (or each) machine learning predictor, according to an embodiment. As in FIG. 5, the machine learning predictor 700 may include a first feature extractor 702, a second feature extractor 704 and a fully connected layer 706. However, in contrast to the arrangements described above in which absolute values of performance metrics are output, in this arrangement, the machine learning predictor does not produce faithful estimates but simply preserves the ranking of the models and the hardware. This may be particularly useful as described below when attempting to obtain the best results in NAS because it is typically more important to focus on accurately predicting which are the best performing candidates rather than accurately predicting the absolute values. Thus, the machine learning predictor may also include a classifier 708 which compares the results from the fully connected layer and outputs a ranking.

As before, each feature extractor 702, 704 may be a graph based feature extractor each of which extracts a graph based representation of the input received at that extractor. A dashed line is shown around the feature extractors to illustrate that both share weights, i.e. have the same weights. In other words, each input may be processed by an identical feature extractor. In this arrangement, the input to each feature extractor must be directly comparable. Accordingly, if the input to the first feature extractor 702 is a neural network model, the input to the second feature extractor 704 is a different neural network model. Thus, each feature extractor may extract a graphical representation of the input neural network model as described in operation S406 of FIG. 4a. Similarly, if the input to the first feature extractor 702 is a hardware arrangement, the input to the second feature extractor 704 is a different hardware arrangement. Thus, each feature extractor may extract a graphical representation of the input hardware arrangement as described in operation S306 of FIG. 3a. The arrangement of FIG. 7 also allows a paired combination of neural network model and hardware arrangement to be input to the first feature extractor 702 and a different paired combination of neural network model and hardware arrangement to be input to the second feature extractor 704. In the second paired combination, one or both of the neural network model and hardware arrangement may be different.

Each feature extractor 702, 704 may extract a graphical representation of the input which it received. The two graphical representations may then be separately used to predict the performance of each input using the fully connected layer. If the inputs are both neural network models, a fixed hardware arrangement is optionally input as described in relation to operation S408 of FIG. 4a so that the performance of each input may be predicted using the fully connected layer 706 as described in operation S410 of FIG. 4a. Similarly, if the inputs are both hardware arrangements, a fixed neural network model is optionally input as described in relation to operation S308 of FIG. 3a so that the performance of each input may be predicted using the fully connected layer 706 as described in operation S310 of FIG. 3a. The inputs may also be two paired arrangements of neural network model and hardware arrangement. A dashed line is shown around the feature extractors to illustrate that both share weights.

For each graphical representation, a performance score is generated and may be input to the classifier as a two-valued vector (score 1, score 2). The two performance scores from the fully connected layer 706 are then compared using the classifier 708. The classifier may be any suitable module, e.g. a SoftMax classifier or a sigmoid classifier. Merely as an example, the SoftMax classifier may use the following Equation [5]:

$${σ ( \vec{z} )}_{i} = \frac{{e}^{{z}_{i}}}{{\sum }_{j = 1}^{K} {e}^{{z}_{j}}} \qquad [ Equation 5 ]$$

where z is the input vector (z₀, . . . , z_{K})—i.e. the vector of performance scores, Zᵢ is an element within the input vector and can have any real value (positive, negative or zero), K is the number of classes in the multi-class classifier, e.g. 2 in the binary relation predictor. It is noted that the sum on the bottom of the formula is a normalization term and ensures that all the output values of the function will sum to 1, thus constituting a valid probability distribution.

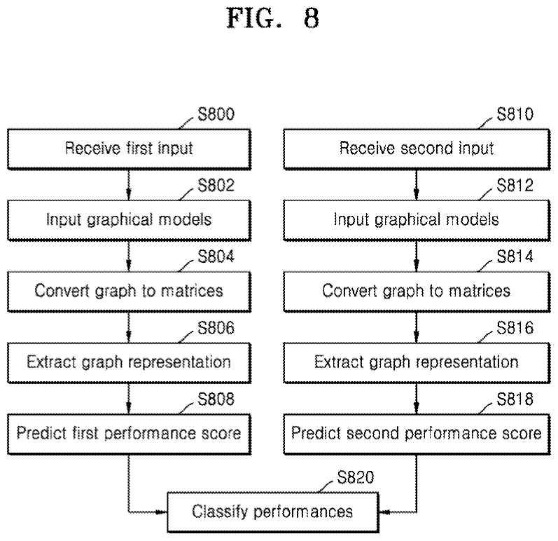

FIG. 8 is a flow chart illustrating steps to perform performance prediction using the server of FIG. 1 and particularly the machine learning predictor of FIG. 7 when the inputs are paired combinations of neural network models and hardware arrangements, according to an embodiment. As illustrated, operation S800 may include receiving a first input and in parallel receive a second input (operation S810). Each of the first and second input may be a paired combination of a neural network model implemented on a hardware arrangement. Each neural network model and each hardware arrangement may be selected from a plurality of designs which have been generated manually or automatically. Operations S802 and S812 may input graphical models and for each paired combination, a graphical model for the neural network model and a graph model for the hardware arrangement may be input. The graphical models may also be generated manually or automatically as described above.

As before, the graphical models may be represented as matrices (operations S804, S814) so that a final graphical representation may be extracted using the first and second feature extractors, respectively (operations S806, S816). The first and second feature extractors may each use a graph convolutional network having k layers. The inputs to the first feature extractor may be the adjacency matrix A_{N1} and an initial feature matrix V_{N1}⁰ both of which describe the first neural network model together with the adjacency matrix A_{H1} and an initial feature matrix V_{H1}⁰ both of which describe the first hardware arrangement. The inputs to the second feature extractor may be the adjacency matrix A_{N2} and an initial feature matrix V_{N2}⁰ both of which describe the second neural network model together with the adjacency matrix A_{H2} and an initial feature matrix V_{H2}⁰ both of which describe the second hardware arrangement. For each of the layers n=0 to n=k−1 in the first feature extractor, the layer wise propagation rule may be defined by Equations [6] and [7], respectively

V_{N}ⁿ⁺¹=g(V_{N}ⁿ,A_{N})=σ(A_{N}V_{N}ⁿW_{N}ⁿ) [Equation 6]

V_{H1}ⁿ⁺¹=g(V_{H1}ⁿ,A_{N1})=σ(A_{H1}V_{H1}ⁿW_{H1}ⁿ) [Equation 7]

where W_{H1}ⁿ and W_{N1}ⁿ are the weight matrices for the first hardware arrangement and the first neural network model respectively at the n-th layer, g is the propagation function and σ( ) is a non-linear activation function specific to graph convolution as described above. Similarly, for each of the layers n=0 to n=k−1 in the second feature extractor, the layer wise propagation rule is, respectively

V_{N2}ⁿ⁺¹=g(V_{N2}ⁿ,A_{N2})=σ(A_{N2}V_{N2}ⁿW_{N2}ⁿ)

V_{H2}ⁿ⁺¹=g(V_{H2}ⁿ,A_{N2})=σ(A_{H2}V_{H2}ⁿW_{H2}ⁿ)

where W_{H2}ⁿ and W_{N2}ⁿ are the weight matrices for the second hardware arrangement and the second neural network model respectively at the n-th layer, g is the propagation function and σ( ) is a non-linear activation function specific to graph convolution as described above.

As before, in the graph convolution method, there are a plurality of weight matrices. The weights may be obtained during training, including using optional initialization from a source predictor. The weights obtained from training may be input before the graphical representations are extracted.

Once the graphical representations are output, the performance of the first neural network model on the first hardware design may be predicted at operation S808 and the performance of the second neural network model on the second hardware design may be predicted (operation S818). The performance may be predicted using the feature vectors which are output from the first and second feature extractors respectively. The output first and second performance scores may simply be scores which are representative of the performance of each paired model and hardware arrangement. It is not necessary for the scores to be as accurate as the outputs described in the previous arrangements, the scores simply need to be sufficiently accurate to allow the final operation.

Operation S820 may classify the performances of each paired model and hardware arrangement relative to each other. In other words, the first paired model and hardware arrangement is ranked higher or lower than the second paired model and hardware arrangement based on a comparison of the first and second performance scores. The classification may be in the form of a probability distribution, e.g. (0.9, 0.1) which shows that the probability that the first input is better than the second input is 90% and the probability that the second input is better than the first input is 10%. In other words, the first paired arrangement of model and hardware is ranked higher than the second paired arrangement and there is also a confidence score associated with this ranking.

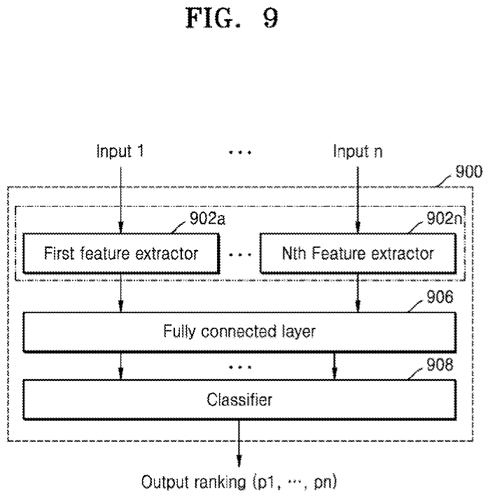

Comparing a pair of inputs in such a way may be termed prediction in binary relation. It will be appreciated that the methodology may be expanded to allow multiple arrangements to be compared and a predictor for such an N-ary relation prediction this is schematically illustrated in FIG. 9.

FIG. 9 is a schematic block diagram showing another possible arrangement of a (or each) machine learning predictor, according to an embodiment. The machine learning predictor 900 may include a plurality of feature extractors 902a, . . . , 902n. Only two are illustrated for simplicity. Each feature extractor receives a separate input and all the inputs are directly comparable. For example, the inputs may be a plurality of neural network models, a plurality of hardware arrangements or a plurality of paired neural network models and hardware arrangements. Each feature extractor extracts a graphical representation of the input which it received and as in the binary arrangement, each feature extractor shares weights. The two graphical representations are then separately used to predict the performance of each input using the fully connected layer 906. The plurality of performance scores, e.g. are output from the fully connected layer 906 as an n-valued vector and are then compared using the classifier 908. The classifier ranks the performances and may optionally output a confidence score associated with the ranking.

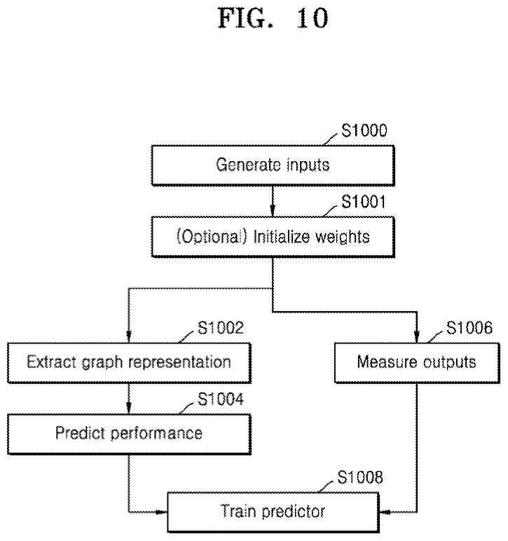

As referenced above, each of the predictors needs to be trained and FIG. 10 shows a method of training a machine learning predictor, according to an embodiment. Operation S1000 may include generating a plurality of inputs. The inputs may depend on whether the predictor is being used to predict the performance of a neural network only, a hardware arrangement only or a paired combination of neural network and hardware arrangement.

As explained above, the predictor may use one or more weights, for example weight matrices in the graph convolution method for extracting a graphical representation, and/or one or weights in the fully connected layer for predicting performance. These weights may be obtained during the training stage. An initial value for the weights needs to be input. As shown in FIG. 10, this may be done by optionally initializing the weights based on the weights obtained from training another predictor, termed a source predictor. Alternatively, the weights may be randomly generated.

As explained above, the metrics may be one or more of accuracy, latency, energy consumption, thermals and memory utilization. Where possible, the measured metric should also match the predicted metric. However, it may be possible that the measured data is not available in large quantities for all models and hardware or may be too costly to acquire in large quantities. When the data is not available or too costly, the predictor may be initially trained on another measured metric, e.g. latency, for which there is a larger, less expensive dataset. The predictor may then be fine-tuned using the smaller set of training data available for the targeted metric, e.g. accuracy. Such training may be termed transfer learning. For example, a dataset may contain 10,000 models without any accuracy measurements but the latency of 1000 of these models has been measured. Accordingly, a latency predictor may be trained using the 1000 models and then transferred to an accuracy predictor. For example, the weights of the accuracy predictor may be initialized with those of the latency predictor.

At operation S1002, a graph representation may be extracted using the feature extractor(s), and at operation S1004, the performance of each output graph representation may be predicted. When the input is one of a plurality of hardware arrangements, as described in FIG. 3a, the performance metrics which are output may be one or both of the predicted performance of each hardware component/device and the predicted performance of a fixed neural network model on the whole hardware arrangement. When the input is one of a plurality of neural network models, as described in FIG. 4a, the performance metrics which are output may be one or both of the predicted performance of each operation and the predicted performance of the neural network model running on a fixed hardware arrangement. When the input is a paired neural network model and hardware arrangement, as described in FIG. 6, the performance metrics which are output may be one or all of the predicted performance of each operation, the predicted performance of each hardware component/device and the predicted performance of the neural network model running on the paired hardware arrangement.

The predictor may be trained with measurements of the performance of neural network models on hardware arrangements. Thus, as shown in FIG. 10, the training process may include an operation S1006 of measuring outputs. For optimal training, the measured outputs should match the predicted outputs of the predictor. Thus, if the predictor is predicting performance of each hardware component/device and the predicted performance of a fixed neural network model on the whole hardware arrangement, the measurements must be the measured performance of each hardware component/device and the measured performance of a fixed neural network model on the whole hardware arrangement. Similarly, if the predictor is predicting performance of each operation and the predicted performance of the neural network model on a fixed hardware arrangement, the measurements must be the measured performance of each operation and the measured performance of the neural network model on the hardware arrangement.

The measurements are used to train the predictor (operation S1008) as is well known in the art. For example, the measurements are compared to the output predictions and the objective is to minimize the difference between the prediction and the measured value. Merely as an example, the predictor may be trained using a randomly sampled set of 900 models from a database, such as the NAS-Bench-201 dataset. 100 random models may be used for validation and the remaining models within the dataset may be used for testing. As explained above, in relation to operation S1001, the training may include a first operation in which the predictor is trained using a large dataset which relates to a different performance metric and is then fine-tuned on a smaller dataset which relates to the target performance metric. The training may result in the weights for the extraction and/or prediction operations being obtained.

In the predictors of FIGS. 7 and 9, the output is a ranking of the relative performance of the inputs. For the arrangement of FIG. 7, the output is a pair of probabilities (p₁, p₂) where p₁ is the probability that the first pairing is better than the second pairing and p₂ is the probability of the opposite. This is extended in FIG. 9 to output a set of probabilities (p₁, . . . , pₙ) where p₁ is the probability that the first pairing is better than all the other pairings. The output set of probabilities may be termed a distribution. The training of such predictors may compare the output distribution to the distribution obtained from the ground-truth accuracy of the two models. In other words, the measured values may be compared to determine the correct ranking or distribution—ground truth. This ground truth distribution is compared with the predicted distribution and the objective of the training operation is to minimize the difference between the two distributions.

An application of the methods described above is in a neural architecture search (NAS). As described above, NAS permits the design of a competitive neural network. As described in “BRP-NAS: Prediction based NAS using GCNs” by Dudziak et al published as arXIV:2007.08668, which is incorporate by reference herein in its entirety, the cost of NAS critically depends on the sample efficiency, which reflects how many models need to be trained and evaluated during the search. In many of the methods described above, the neural network is considered together with its associated hardware design. Thus, the methods described above may also be used to design the hardware to efficiently implement the competitive neural network model.

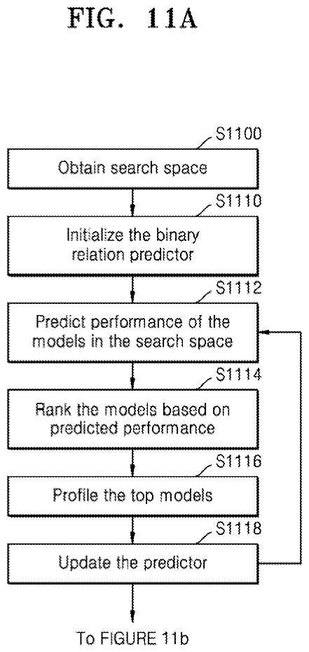

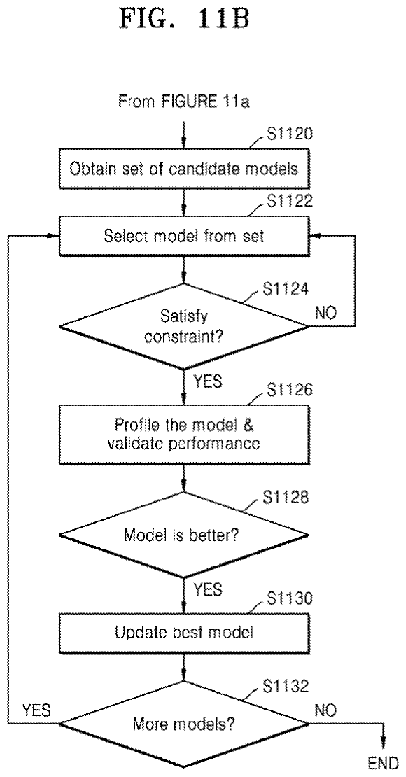

The binary relation predictor described in FIG. 8 may be applied in a neural architecture search as illustrated in FIGS. 11a and 11b. FIG. 11a illustrates a first phase of the search which may be termed a training phase. In this phase, the binary relation predictor is trained via an iterative data selection. FIG. 11b follows from FIG. 11a and illustrates a second phase in which a search for the best model is conducted using the trained predictor.

As shown in FIG. 11a, operation S1100 may include obtaining the search space. We are considering models which pair both neural network models and associated hardware arrangements and thus the search space is large. The search space may be denoted by M and there may be a budget of T models which can be trained and I iterations. Operation S1110 may include an initialization operation which involves selecting a random sample of K models from the search space M. K is a much smaller number than the total number of models in the search space. Optionally, the weights may be initialized using the weights from an existing predictor. The predictor is then trained, during the initialization phase, based on these K models.

Operation S1112 may include predicting performance of all the models in the search space using the predictor which was trained on K models in the initialization phase. The predicted performance may use accuracy as a performance metric. The predicted performance is used to rank all the models by the pairwise comparison process described previously (operation S1114).

Once the top ranked models have been identified, a set of the top models are selected. For example, the set may include the top α*T/I models together with another (1−α)*T/I models from the top M/2ⁱ models where α is a factor between 0 and 1 and i is the iteration counter. There is then a profiling operation (operation S1116) in which the set of top models may be profiled or fully trained depending on the nature of the performance metric. The binary relation predictor may be trained using the relative performance of each pair of models. By fully trained, the predictor is trained “properly”, that is, in the same way the predictor would be trained if the training was taking place outside of NAS. By contrast, some NAS methods, while searching for good models, use approximated/fast training schemes instead of training until convergence (usually referred to as “proxy-task training”). Tuning α results in a trade-off between exploitation and exploration and thus α=0.5 may be used to give a balance.

As an illustrative example of operation S1116, consider using accuracy as the performance metric. The previous operation S1114 ranks the models according to the “predicted” accuracy. Thus, in operation S1116, the top ranked models are selected and then trained to obtain the “ground-truth” accuracy. The training may be done as shown in FIG. 10 or using any known techniques. Similarly, as another illustrative example, operation S1114 may have been used to rank the models according to the “predicted” latency. Thus, in operation S1116, the top ranked models are selected and then profiled to obtain the “ground-truth” latency. In each case (latency or accuracy as performance metric), any models failing a constraint as explained below, may be rejected.

The trained predictor may then be updated using the models with “ground-truth” performance (operation S1118). These models may then be used to update the predictor. As shown in FIG. 11a, further training may be done by iterating through the predict, rank and profile operations and the training process may be terminated after i iterations.

Example Algorithm [1] may be used to carry out the operations of FIG. 11a is set out below and the notes are denoted by //.

[Algorithm 1]

| Input: (i) Search space S, (ii) budget for predictor training K (number ofmodels), (iii) number of | |
|---|---|
| iterations I, (iv) metric 1 requirement R and predictor of metric 1P_{R}, (v) trade-off factor α between 0 | |
| and 1, (vi) overall maximum number of models we can afford to train M,M>K | |
| Output: The best found model m* | // the best found medal according to metric 2 |

| | | |
|---|---|---|
| 1 | m*←NONE | |
| 2 | C← { s \| s ∈ S ∧ P_{R}(s)satisfies R} | // models which are too expensive are removed |

| | | |
|---|---|---|
| 3 | T← ø | // training set for the binary predictor |

| | |
|---|---|
| 4 | BP← initialize binary predictor with weights from P_{R}// optional transfer from P_{R} |
| 5 | for i← 1 to / do |

// update training set for the predictor, in eachiteration, we add K/I models in total //

| 6 | M← (from C. select the top α × K/I modelsand randomly select (1 − α) × K/I models from top | |
|---|---|---|
| | \|C\|/2ⁱ which are notalready in T) | // completely random for i= 1 |

| | | |
|---|---|---|
| 7 | foreach m ∈ M do | // models higher in C first |

| | | |
|---|---|---|
| 8 | a← metric_2(m) | // get metric a of model m |
| 9 | T← T ∪ {(m, a)} | // add model-metric pair to set |

| | |
|---|---|
| 10 | // keep track of the trained models throughout theentire procedure // |

| | |
|---|---|
| if metric_1(m) satisfies requirement R then | // check if m truly satisfies the |

requirement

| | |
|---|---|
| 11 | update m* if m happensto be better |

| | |
|---|---|
| 12 | end |

| | |
|---|---|
| 13 | end |

// update the predictor //

| | | |
|---|---|---|
| 14 | foreach ((mᵢ, a₁), (m₂, a₂)) ∈ T² s.t. m₁ ≠ m₂ do | // possibly shuffle and batch // |

| | |
|---|---|
| 15 | I ← softmax(BP(m₂, m₂)) |

| | |
|---|---|
| 16 | t ← softmax([a₁, a₂)I) |

| | |
|---|---|
| 17 | optimize BP to minimizeKL-divergence between t and I |

| | |
|---|---|
| 18 | end |

// use the updated predictor to reevaluate the models in C//

| | |
|---|---|
| 19 | C← sort C using BP to comparemodels |

| | |
|---|---|
| 20 | end |

In Algorithm [1] above, the set of models which are used to train the predictor are denoted by T. Trained models are stored as pairs (model, performance) and the predictor is trained by taking all possible pairs (m1, a1), (m2, a2) from the set T and optimized towards reducing the KL-divergence between the probability distributions constructed by the binary predictor (line 15 in the algorithm) and the “measured” performance of the two models obtained by their training (line 16). The optimization may be done using any optimizer etc., and in deep learning these usually rely on backpropagation and stochastic gradient descent (or one of its many variations). For example, the optimizer may be the optimizer termed AdamW (described_in “Decoupled Weight Decay Regularization by Loshchilov et al published by Cornell University in Computer Science, Machine Learning in November 2017). Training of the predictor is done iteratively, so in each iteration 1) some models from the search space are trained and included in the training set of the predictor, 2) the predictor is updated, 3) the predictor is used to re-score untrained models in the search space in order to pick the good ones in operation 1 of the next iteration.

Once the training is complete as shown in FIG. 11a and the example Algorithm [1] above, the candidate models in C are ordered by using the trained predictor to score and sort the models. The method may now move to a search phase as illustrated in FIG. 11b and there is no further training of the predictor at this stage. The searching phase starts by obtaining a set of candidate models M which represent those models having the best performance as determined by the trained predictor (operation S1120).

A model m is then selected from the set M (operation S1122) and it is determined whether or not the model satisfies a constraint based on performance (operation S1124). For examples, the constraint may be to determine whether the latency of the selected model is below a maximum acceptable value for latency. If the model does not satisfy the constraint, it is discarded and another model is selected. It is noted that the constraint is only considered to ensure that the returned best model matches the constraint. In other words, the constraint (in this case based on latency) is not considered when training the predictor or deciding if a (model, accuracy) pair should be included in the training set of the predictor.

If the constraint is satisfied, the model may be profiled to obtain the ground truth values to validate the selection. In other words, the performance of the selected model is then profiled and validated (operation S1126). The method then determines whether the selected model is better than the current best model (operation S1128). If the model is better, the best model m* is updated and the method moves to the next operation. When the model is not better, the update is skipped and the method moves the next operation.

The next step is to determine whether there are any more models m in the set M which have not yet been evaluated (step S1130). If there are further models to evaluate, the method loops back and selects the next model. The process is then repeated. When there are no more models to consider, the process is ended and the best model m* is output.

Example Algorithm [2] may be used to carry out the operations of FIG. 11b is set out below, using the terminology above:

[Algorithm 2]

| | | |
|---|---|---|
| 22 | foreach m ∈ M do | // consider better models in C first // |

| | | |
|---|---|---|
| 23 | if metric_1(m) satisfies requirement R then | // check if m truly satisfies the |

requirement

| | |
|---|---|
| 24 | a← metric_2(m) |
| 25 | update m* if m happens to be better |

| | |
|---|---|
| 26 | end |

| | |
|---|---|
| 27 | end |

By focusing on high performing models, the search process above is able to find better models. After the first iteration, the method described above is able to aggressively search for better models, thus increasing its exploitation and reducing its exploration in every following iteration.

In summary, the graph-based approach described above reflects the key elements and characteristics of one or both of the neural network model and hardware arrangements (depending on which arrangement described above is used) by taking the graph topology into account. For example, the graph topology allows a consideration of whether operations may be executed in parallel on target hardware or how the performance of one node is affected by its neighbors. This approach is thus likely to outperform the prior art methods. For example, layer-wise predictors assume sequential processing of operations and do not allow for the consideration of parallelism. This may lead to inaccurate measurements compared to the present methods. Direct measurements are typically slow and require significant human effort to develop paired arrangements of neural network models and hardware arrangements. Similarly, a cycle-accurate simulator is typically slow and requires significant human effort.

Those skilled in the art will appreciate that while the foregoing has described what is considered to be the best mode and where appropriate other modes of performing present disclosure, the present disclosure should not be limited to the specific configurations and methods disclosed in this description of the preferred embodiment. Those skilled in the art will recognize that present disclosure have a broad range of applications, and that the embodiments may take a wide range of modifications without departing from any inventive concept as defined in the appended claims.

1. A method of predicting performance of a hardware arrangement or a neural network model, the method comprising:
obtaining one or more of a first hardware arrangement or a first neural network model, the first hardware arrangement comprising a first plurality of interconnected components or devices, the first neural network model comprising a first plurality of operations;
obtaining a first graphical model comprising a first plurality of nodes corresponding to the obtained first hardware arrangement or the obtained first neural network model, wherein each node of the first plurality of nodes corresponds to a respective component or device of the first plurality of interconnected components or devices or a respective operation of the first plurality of operations;
extracting, based on the first graphical model, a first graphical representation of the obtained first hardware arrangement or the obtained first neural network model;
predicting, based on the first graphical representation, performance of the obtained first hardware arrangement or the obtained first neural network model; and
outputting the predicted performance.

2. The method of claim 1, wherein the extracting of the first graphical representation of the obtained first hardware arrangement comprises extracting a feature vector for each node of the first plurality of nodes in the first graphical model.

3. The method of claim 2, wherein:
based on the first hardware arrangement being a single-chip device comprising the first plurality of interconnected components, the feature vector comprises at least one of a component type or a bandwidth; and
based on the first hardware arrangement being a system comprising the first plurality of interconnected devices, the feature vector comprises at least one of a processor type, a device type, a clock frequency, a memory size or a bandwidth.

4. The method of claim 1, wherein the extracting of the first graphical representation of the obtained first neural network model comprises extracting a feature vector for each node of the first plurality of nodes in the first graphical model.

5. The method of claim 4, wherein the feature vector comprises at least one of an input, an output, a 3×3 convolutional layer, a 1×1 convolutional layer, or an averaging operation.

6. The method of the claim 1, wherein the predicting of the performance of the obtained first hardware arrangement comprises at least one of:
predicting individual performances of each of the first plurality of interconnected components or devices; or
predicting overall performance of the first hardware arrangement.

7. The method of claim 6, wherein:
the first graphical model comprises a global node; and
the predicting of the overall performance of the first hardware arrangement is based on the global node.

8. The method of claim 1, wherein the predicting of the performance of the obtained first neural network model comprises predicting individual performances of each of the first plurality of operations.

9. The method of claim 1, further comprising:
obtaining a second hardware arrangement comprising a second plurality of interconnected components or devices;
obtaining a second graphical model comprising a second plurality of nodes corresponding to the obtained second hardware arrangement, wherein each node of the second plurality of nodes corresponds to a respective component or device of the second plurality of interconnected components or devices;
extracting, based on the second graphical model, a second graphical representation of the obtained second hardware arrangement;
predicting, based on the second graphical representation of the second hardware arrangement, performance of the obtained second hardware arrangement; and
comparing the predicted performance of the obtained first hardware arrangement and the predicted performance of the obtained second hardware arrangement,
wherein the outputting of the predicted performance of the first hardware arrangement comprises outputting an indication of the predicted performance the first hardware arrangement relative to the predicted performance of the second hardware arrangement.

10. The method of claim 1, further comprising:
obtaining a second neural network model comprising a second plurality of operations;
obtaining a second graphical model comprising a second plurality of nodes corresponding to the obtained second neural network model, wherein each node of the second plurality of nodes corresponds to a respective operation of the second plurality of operations;
extracting, based on the second graphical model, a second graphical representation of the obtained second neural network model;
predicting, based on the second graphical representation of the obtained second neural network model, performance of the obtained second neural network model; and
comparing the predicted performance of the obtained first neural network model and the performance of the obtained second neural network model,
wherein the outputting of the predicted performance of the obtained first neural network model comprises outputting an indication of the predicted performance the obtained first neural network model relative to the predicted performance of the obtained second neural network model.

11. The method of claim 1, wherein:
a first paired combination comprises the obtained first hardware arrangement and the obtained first neural network model;
the obtaining of the first graphical model comprises obtaining a first hardware graphical model corresponding to the obtained first hardware arrangement and a first network graphical model corresponding to the obtained first neural network model;
the extracting of the first graphical representation comprises extracting a first hardware graphical representation of the obtained first hardware arrangement and a first network graphical representation of the obtained first neural network model; and
the method further comprises:
obtaining a second paired combination comprising a second hardware arrangement and a second neural network model;
obtaining a second hardware graphical model corresponding to the second hardware arrangement and a second network graphical model corresponding to the second neural network model;
extracting, based on the second hardware graphical model and the second network graphical model, a second hardware graphical representation of the second hardware arrangement and a second network graphical representation of the second neural network model;
predicting, based on the first hardware graphical representation and the first network graphical representation, performance of the first paired combination;
predicting, based on the second hardware graphical representation and the second network graphical representation, performance of the second paired combination;
comparing the predicted performance of the first paired combination and the predicted performance of the second paired combination; and
outputting a relative performance of the first paired combination compared to the second paired combination.

12. The method of claim 1, further comprising:
obtaining a plurality of hardware arrangements;
predicting the performance of the obtained first neural network model on each hardware arrangement of the plurality of hardware arrangements;
comparing the performances for each hardware arrangement of the plurality of hardware arrangements; and
identifying, based on a predetermined performance criteria, a hardware arrangement among the plurality of hardware arrangements.

13. The method of claim 1, further comprising:
obtaining a plurality of neural network models;
predicting the performance of the obtained first hardware arrangement on each neural network model of the plurality of neural network models;
comparing the performances for each neural network model of the plurality of neural network models; and
identifying, based on a predetermined performance criteria, a neural network model among the plurality of neural network models.

14. A server comprising:
a memory storing at least one instruction; and
at least one processor configured to execute the at least one instruction to:
obtain one or more of a first hardware arrangement or a first neural network model, the first hardware arrangement comprising a first plurality of interconnected components or devices, the first neural network model comprising a first plurality of operations;
obtain a first graphical model comprising a first plurality of nodes corresponding to the obtained first hardware arrangement or the obtained first neural network model, wherein each node of the first plurality of nodes corresponds to a respective component or device of the first plurality of interconnected components or devices or a respective operation of the first plurality of operations;
extract, based on the first graphical model, a first graphical representation of the obtained first hardware arrangement or the obtained first neural network model;
predict, based on the first graphical representation, performance of the obtained first hardware arrangement or the obtained first neural network model; and
output the predicted performance.

15. A machine-readable medium containing instructions that, when executed, cause at least one processor of an apparatus to perform operations corresponding to the method of claim 1.

16. A method of searching for a model based on performance comprising:
obtaining a plurality of candidate models comprising a first candidate model;
determining whether the first candidate model satisfies a predetermined constraint;
based on the first candidate model satisfying the predetermined constraint, profile the first candidate model to obtain ground truth values for the first candidate model;
obtain a performance of the first candidate model based on the ground truth values for the first candidate model;
compare the performance of the first candidate model to a performance of a current best model; and
based on the performance of the first candidate model being higher than the current best model, update the current best model to be the first candidate model.

17. The method of claim 16, wherein the obtaining of the plurality of candidate models comprises:
obtaining a plurality of models;
randomly selecting a first portion of the plurality of models;
training a predictor based on the first portion of the plurality of models, wherein the predictor is configured to predict model performance;
predicting a performance of each of the plurality of models; and
selecting a second portion of the plurality of models having a highest performance as the plurality of candidate models.
